(19) United States
(12) Patent Application Publication
(10) Pub. No.: US 2026/0062562 A1
(43) Pub. Date: Mar. 5, 2026

(54) SYSTEM FOR PRODUCING SUPERHYDROPHOBIC RUBBER AND PLASTIC COMPOUNDS WITH ANTIFOULING PROPERTIES

(71) Applicant: BARNACLE-BLOCKER, LLC, Cortez, FL (US)

(72) Inventors: Lewis Steven Beckham, Cortez, FL (US); Jacob Adelowo, Rocky Mount, NC (US)

(21) Appl. No.: 19/379,439

(22) Filed: Nov. 4, 2025

Related U.S. Application Data
(63) Continuation of application No. 19/032,617, filed on Jan. 21, 2025, now Pat. No. 12,480,004.
(60) Provisional application No. 63/732,448, filed on Aug. 19, 2024.
(60) Provisional application No. 63/883,484, filed on Sep. 17, 2025.

(51) Int. Cl. C09D 5/16; C09D 7/63; C09D 7/65; C09D 13/00; C09D 191/00; C09D 191/06

(52) U.S. Cl. CPC C09D 5/1625; C09D 5/1637; C09D 5/1656; C09D 7/63; C09D 7/65; C09D 13/00; C09D 191/005; C09D 191/06

(57) ABSTRACT

A system, composition, and method are disclosed for producing superhydrophobic and antifouling polymer materials. The invention incorporates antifouling agents such as capsaicin, medetomidine, tralopyril, or zinc pyrithione together with hydrophobic additives such as polydimethylsiloxane, polytetrafluoroethylene, fluoropolymers, or surface-modified nanoparticles into natural or synthetic rubber and thermoplastic matrices. In one approach, pre-formulated antifouling compositions are added as solid components during compounding, and in another, the polymer itself serves as a carrier medium for direct incorporation of the active ingredients. The compounded materials exhibit controlled release of antifouling agents, low surface energy, and superhydrophobic behavior that reduces drag and resists attachment of marine and freshwater organisms. A manufacturing system may include compounding, monitoring, and forming units, with optional plasma or laser treatment to enhance nanoscale roughness. The invention enables durable, environmentally responsible materials for marine, industrial, and consumer applications requiring long-term fouling resistance.

### CROSS-REFERENCE TO RELATED APPLICATIONS

This application claims the benefit of U.S. patent application Ser. No. 19/032,617 filed Jan. 21, 2025, which claims the benefit of provisional patent application 63/732,448 filed Aug. 19, 2024, and provisional patent application 63/883,484 filed Sep. 17, 2025, all of which are hereby incorporated herein in their entireties.

### FIELD OF THE INVENTION

The present invention relates to the production of elastomeric and thermoplastic compounds having specialized surface and bulk properties. More specifically, the invention is directed to a system and method for incorporating antifouling agents and hydrophobic components into plastics and natural rubbers in order to create superhydrophobic materials with long-term resistance to the attachment of macrofouling organisms. The invention further relates to the use of such materials in marine, industrial, and consumer applications where resistance to biofouling, reduced drag in water, and enhanced durability are advantageous.

### BACKGROUND

Biofouling is a persistent problem for marine vessels, submerged structures, and water-handling equipment. Organisms such as barnacles, mussels, algae, and bacterial films readily attach to exposed surfaces, leading to increased drag, decreased efficiency, structural degradation, and elevated maintenance costs. The economic impact of fouling is substantial, as it raises fuel consumption for ships, clogs intake pipes and cooling systems, and compromises the performance of underwater sensors and autonomous vehicles. Traditional approaches to fouling control have relied heavily on coatings or paints containing toxic biocides. While these coatings can provide some level of protection, they often require frequent reapplication, tend to leach active ingredients uncontrollably into the environment, and may pose ecological risks.

In an effort to reduce environmental impact, research has explored antifouling strategies that rely on non-lethal behavioral modification of organisms rather than toxic action. For example, medetomidine has been shown to prevent barnacle larvae from attaching to surfaces by disrupting their settlement behavior, without killing the organisms outright. Capsaicin, another well-known bioactive compound, has also been demonstrated to discourage attachment. In previous work disclosed in U.S. Pat. No. 10,053,584, a crayon-like composition containing capsaicin, beeswax, and hydrogenated triglycerides was developed to coat surfaces in order to prevent fouling. That composition was durable, insoluble in water, and could even be applied underwater, making it highly practical for both recreational and commercial use. Additional research, disclosed in later international filings, broadened the scope of antifoulant agents that could be employed, such as tralopyril and zinc pyrithione, to address a wider range of fouling organisms.

In parallel, significant advances have been made in the field of superhydrophobic materials. Compounds such as polydimethylsiloxane and polytetrafluoroethylene have been shown to impart extremely low surface energy to treated substrates. When combined with micro- or nanoscale surface structuring, these compounds can achieve contact angles greater than 150 degrees, creating surfaces that shed water and contaminants with remarkable efficiency. Superhydrophobic surfaces not only repel water but also reduce drag when submerged, which has clear benefits for marine applications including ship hulls, propellers, and underwater vehicles.

Despite these advances, there remains a clear need for materials that integrate antifouling and hydrophobic properties directly into the bulk of elastomers and plastics, rather than as surface coatings. Coatings can be damaged, worn away, or unevenly applied, whereas bulk-modified materials retain their properties throughout their service life. Furthermore, a system capable of producing such materials in a scalable and versatile manner would provide significant benefits across multiple industries. By combining antifoulant agents with hydrophobic polymers and dispersing them uniformly throughout elastomeric or thermoplastic matrices, it is possible to create finished articles that resist fouling and reduce drag without requiring additional surface treatments.

The present invention addresses these needs by providing a system for producing plastic and natural rubber compounds that incorporate antifoulants and superhydrophobic agents into their composition. These materials provide long-term resistance to biofouling organisms while simultaneously enhancing hydrodynamic efficiency, resulting in durable, environmentally responsible, and high-performance products for marine, industrial, and consumer applications.

### SUMMARY

The present invention provides a polymer composition, a system for producing such a composition, and a method of manufacture that together yield materials exhibiting both superhydrophobic and antifouling properties integrated directly into the bulk matrix of rubber or plastic compounds. The invention overcomes the limitations of conventional surface coatings by embedding antifouling and hydrophobic agents within the polymer structure, thereby ensuring that the functional characteristics remain effective even after abrasion, wear, or long-term environmental exposure.

In one aspect, the invention provides a polymer composition comprising a base polymer selected from natural rubber, synthetic rubber, or thermoplastic resins, at least one antifouling component, and at least one hydrophobic additive. The antifouling component may include natural or synthetic agents such as capsaicin, medetomidine, tralopyril, zinc pyrithione, or combinations thereof. The hydrophobic additive may include polydimethylsiloxane, polytetrafluoroethylene, fluoropolymers, or surface-modified nanoparticles. The composition may be prepared using either of two complementary approaches. In one approach, a pre-formulated antifouling composition, such as a wax-based capsaicin product, is incorporated as a solid additive into the polymer. In another approach, the polymer serves as a carrier medium into which the active antifouling ingredients are directly introduced, optionally as encapsulated micro- or nanoparticles for controlled release. In certain embodiments, both approaches may be combined in a hybrid configuration to provide staged antifouling activity.

In another aspect, the invention provides a system for producing the superhydrophobic and antifouling polymer composition. The system includes a compounding unit configured to blend the base polymer with antifouling and hydrophobic components under controlled temperature and shear conditions, a monitoring subsystem, such as infrared or Raman spectroscopy, to verify uniform dispersion of additives, and a forming unit, such as an extrusion or molding station, to shape the compounded material into finished articles. Optional modules may include surface-modification equipment such as plasma or laser texturing devices that enhance nanoscale roughness and further increase hydrophobic performance.

In a further aspect, the invention provides a method of producing a superhydrophobic and antifouling polymer composition. The method includes providing a base polymer, adding one or more antifouling components and hydrophobic additives, and compounding the mixture to form a homogeneous material. The antifouling component may be introduced as a pre-formulated additive or as a pure or encapsulated active ingredient. The compounded polymer may then be formed into articles by extrusion, injection molding, or compression molding, and may optionally be subjected to surface modification to optimize roughness and contact-angle behavior.

The resulting materials exhibit low surface energy, high water contact angles, and controlled release of antifouling agents, providing durable protection against macrofouling organisms and measurable drag reduction when submerged. Because the antifouling and hydrophobic functionalities are incorporated throughout the material, the performance is retained even after surface abrasion or long-term exposure. The invention thereby provides a scalable, environmentally responsible solution for producing antifouling and superhydrophobic materials suitable for use in marine, industrial, and consumer applications including propellers, hull components, underwater drones, intake pipes, filters, gaskets, footwear, and other products requiring reduced fouling and improved fluid dynamic efficiency.

### BRIEF DESCRIPTION OF THE DRAWINGS

The above objects, as well as additional objects, features and advantages of the present invention, will be more fully appreciated by reference to the following illustrative and non-limiting detailed description of embodiments of the present invention, when taken in conjunction with the accompanying drawings, wherein:

FIGS. 1A, 1,B, 1C, and 1D show the appearance of is a photograph of a series of plates, with the plate on the far left formed according to the invention; and

FIG. 2 is a schematic of a system for producing a superhydrophobic and antifouling polymer composition.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The present invention provides a system and method for producing elastomeric and thermoplastic materials that possess both superhydrophobic and antifouling properties permanently integrated into the bulk matrix of the material. Unlike coatings or surface treatments that rely on adhesion and degrade over time, the invention incorporates active and hydrophobic agents throughout the polymer structure so that the functional properties remain effective even after abrasion, flexing, or surface wear. The resulting materials exhibit long-term resistance to macrofouling organisms such as barnacles, mussels, and algae, exhibit high static water contact angles, and provide reduced drag when submerged in water.

The base polymer may comprise natural rubber or synthetic elastomers such as styrene-butadiene rubber, nitrile rubber, ethylene-propylene-diene monomer, neoprene, or thermoplastic elastomers. In other embodiments, the base polymer may comprise thermoplastic resins including polyethylene, polypropylene, polyvinyl chloride, polycarbonate, polyamide, or acrylonitrile-butadiene-styrene. The specific polymer is selected based on the mechanical performance, environmental exposure, and flexibility required by the intended application.

The invention encompasses two complementary approaches for imparting antifouling functionality into these materials. In a first approach, previously patented or pre-formulated antifouling compositions are introduced directly into the polymer as additive components. One exemplary additive is the crayon-like composition disclosed in U.S. Pat. No. 10,053,584, which contains pharmaceutical-grade capsaicin, beeswax, and hydrogenated vegetable triglycerides. That product, originally designed for direct application to submerged surfaces, can be pelletized or flaked and added to the polymer during compounding. When incorporated in this manner, the additive disperses within the polymer and gradually releases antifouling agents through its waxy carrier. The wax matrix also serves as a natural plasticizer that enhances low-surface-energy behavior and contributes to the hydrophobic performance of the final compound. This approach leverages existing antifouling formulations while embedding them permanently within the polymer matrix.

In a second approach, the polymer itself acts as the carrier medium for the antifouling active ingredients. Pure or formulated actives such as medetomidine, tralopyril, capsaicin, zinc pyrithione, or combinations thereof may be blended directly into the molten polymer during compounding. The polymer thereby functions as both a structural material and a diffusion reservoir, allowing small amounts of active ingredient to be released at the polymer-water interface. To improve distribution and regulate release rates, the active agents may be encapsulated in biodegradable microcapsules made of poly(lactic acid), polycaprolactone, or wax matrices, or immobilized on nanoparticle carriers such as silica or alumina. These encapsulated or supported actives can be introduced into the polymer melt under controlled shear and temperature conditions to avoid degradation and ensure homogeneous dispersion.

Both approaches may also be combined in a hybrid embodiment in which a portion of pre-formulated antifouling composition is included to provide immediate protection while encapsulated or pure active agents are added for long-term release. This combined strategy enables more gradual and extended antifouling activity over time.

Superhydrophobic behavior is achieved through the addition of low-surface-energy materials such as polydimethylsiloxane, polytetrafluoroethylene, fluorinated ethylene-propylene, perfluoroalkoxy, or fluorinated nanoparticles. Polydimethylsiloxane provides flexibility and compatibility with most elastomers, while polytetrafluoroethylene and related fluoropolymers impart high water repellency. These additives are typically present in concentrations of one to twenty percent by weight of the total compound and may have particle sizes ranging from fifty nanometers to ten microns to produce a hierarchical surface morphology that traps air pockets and promotes a Cassie-Baxter wetting state characteristic of superhydrophobic materials.

The antifouling and hydrophobic components may be compounded with the base polymer using conventional processing equipment such as a twin-screw extruder fitted with temperature-controlled zones to maintain processing temperatures below the decomposition threshold of the active ingredients. Sequential feeding or side injection may be used to control residence time and distribution. The compounded melt can then be extruded, cooled, and pelletized for molding or extrusion into finished articles. In some embodiments, a solvent-assisted impregnation process may be used, in which the base polymer is softened in a solvent containing the antifouling actives and then dried, allowing diffusion of the actives into the polymer matrix without high-temperature exposure.

Surface modification may optionally be performed after forming to further enhance hydrophobicity. Plasma treatment, laser texturing, or chemical etching can be applied to increase nanoscale roughness and optimize the wetting characteristics of the surface. Laser ablation may create periodic microgroove patterns, while plasma exposure to oxygen or fluorine may adjust surface polarity and promote long-term water repellency.

A representative manufacturing system 100 is depicted in FIG. 2. The system 100 may include a compounding unit 102 for blending the polymer with antifouling and hydrophobic additives, a monitoring subsystem 104 such as infrared or Raman spectroscopy sensors to verify uniform dispersion, and a forming unit 106 such as an extrusion die or injection mold. Optional modules may include a surface-modification unit 108 to provide plasma or laser treatment, and quality-control instruments such as contact-angle goniometers or drag-reduction test cells may be used to verify performance parameters.

The functional mechanism of the invention arises from a combination of controlled chemical deterrence and physical surface effects. The controlled release of active antifouling compounds maintains a localized concentration near the surface that discourages attachment of larval organisms, while the low-energy, microstructured surface minimizes wetted area and suppresses biofilm formation. These mechanisms collectively provide extended fouling resistance and can reduce boundary-layer turbulence, resulting in lower drag and improved energy efficiency when used on submerged or water-contacting surfaces.

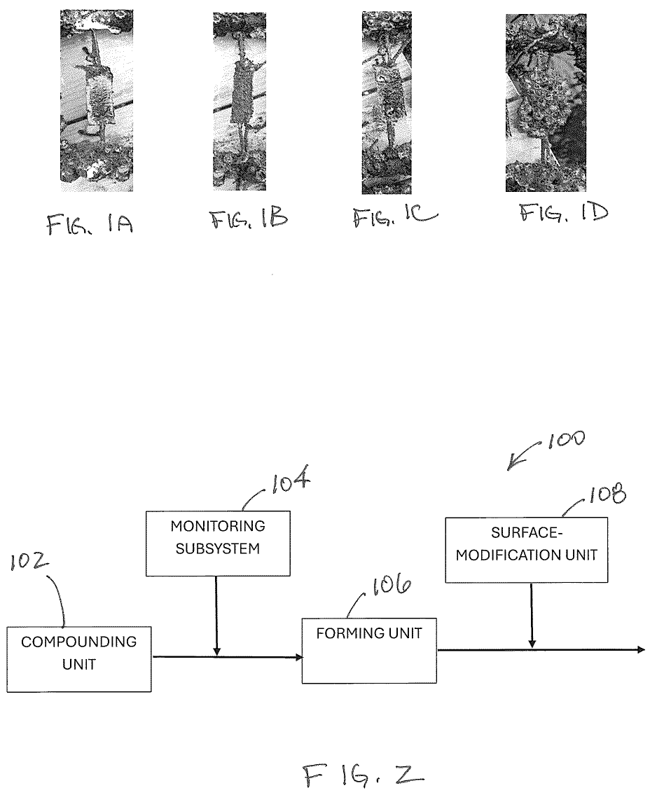

Referring now to FIG. 1A, a plastic article after submersion having 0.5% by weight of the composition is shown. FIG. 1B depicts a plastic article after submersion having 1% by weight of the composition, and FIG. 1C shows a plastic article after submersion having a surface coating only. FIG. 1D shows a plastic article after submersion without any of the inventive composition.

The following embodiments are provided as illustrative examples of how the invention may be implemented. In one illustrative embodiment, natural rubber may be compounded with a pre-formulated capsaicin-beeswax composition together with a hydrophobic additive such as polytetrafluoroethylene to produce a flexible panel material exhibiting hydrophobic and antifouling characteristics. In another illustrative embodiment, polypropylene pellets may be blended with a pre-formulated antifouling additive and polydimethylsiloxane masterbatch to form sheet material suitable for marine or industrial applications. In another example, nylon six may be compounded with encapsulated medetomidine, tralopyril, and polytetrafluoroethylene to form molded components such as propeller blades exhibiting reduced fouling and water adhesion. In a further illustrative embodiment, a liquid polydimethylsiloxane elastomer may include zinc pyrithione and tralopyril prior to curing, resulting in an antifouling membrane suitable for covering submerged sensors. In yet another illustrative embodiment, an EPDM compound may include a mixture of pre-formulated capsaicin-beeswax additive and encapsulated medetomidine, combining immediate antifouling activity with long-term release in a hybrid configuration.

These examples are not intended to represent test data or measured performance but are provided to illustrate the range of possible compositions, processing conditions, and applications achievable using the present system. Because the antifoulant and hydrophobic components are integrated into the polymer, the materials maintain their properties even after wear or abrasion and do not require reapplication. The invention thus provides a durable, scalable, and environmentally responsible solution for manufacturing superhydrophobic, antifouling materials for use in marine, industrial, and consumer products.

Many modifications and other embodiments will come to the mind of one skilled in the art having the benefit of the teachings presented in the foregoing descriptions and the associated drawings. Therefore, it is understood that the disclosure is not to be limited to the specific embodiments disclosed, and that modifications and embodiments are intended to be included within the scope of the appended claims.

That which is claimed is:

1. A polymer composition comprising:
a base polymer selected from natural rubber, synthetic rubber, or a thermoplastic resin;
at least one antifouling component incorporated within the base polymer, the antifouling component selected from capsaicin, medetomidine, tralopyril, zinc pyrithione, or a combination thereof; and
at least one hydrophobic additive incorporated within the base polymer, the hydrophobic additive selected from polydimethylsiloxane, polytetrafluoroethylene, a fluoropolymer, or a surface-modified nanoparticle,
wherein the polymer composition exhibits superhydrophobic behavior and resists attachment of macrofouling organisms when exposed to an aqueous environment.

2. The polymer composition of claim 1, wherein the antifouling component comprises a pre-formulated composition containing capsaicin, beeswax, and a hydrogenated vegetable triglyceride.

3. The polymer composition of claim 1, wherein the antifouling component comprises a pure or encapsulated active ingredient directly blended into the base polymer.

4. The polymer composition of claim 1, wherein both a pre-formulated antifouling composition and an encapsulated antifouling active ingredient are incorporated to provide immediate and sustained antifouling activity.

5. The polymer composition of claim 1, wherein the antifouling component is encapsulated within a biodegradable polymer or wax matrix configured for controlled release of the active ingredient.

6. The polymer composition of claim 1, wherein the hydrophobic additive comprises a mixture of polydimethylsiloxane and polytetrafluoroethylene.

7. The polymer composition of claim 1, wherein the hydrophobic additive is present in an amount between about 1% and about 20% by weight of the composition.

8. The polymer composition of claim 1, wherein the antifouling component is present in an amount between about 0.1% and about 10% by weight of the composition.

9. The polymer composition of claim 1, wherein the surface-modified nanoparticle comprises silica functionalized with a fluoroalkyl silane group.

10. The polymer composition of claim 1, wherein the composition forms an article selected from a marine hull component, propeller blade, rope, underwater drone housing, pipe liner, gasket, or sensor cover.

11. A system for producing a superhydrophobic and antifouling polymer composition, comprising:
a compounding unit configured to blend a base polymer with at least one antifouling component and at least one hydrophobic additive;
a monitoring subsystem configured to detect and verify dispersion uniformity of the antifouling component and hydrophobic additive within the base polymer; and
a forming unit configured to shape the compounded polymer composition into a finished article,
wherein the finished article resists fouling and exhibits superhydrophobic characteristics when immersed in water.

12. The system of claim 11, wherein the compounding unit comprises a twin-screw extruder having temperature-controlled zones to prevent degradation of the antifouling component.

13. The system of claim 11, wherein the monitoring subsystem comprises an infrared or Raman spectroscopy sensor for confirming homogeneity of the blended composition.

14. The system of claim 11, further comprising a surface-modification unit configured to apply plasma treatment or laser texturing to the finished article to enhance nanoscale roughness and hydrophobicity.

15. A method of producing a superhydrophobic and antifouling polymer composition, comprising the steps of:
providing a base polymer selected from natural rubber, synthetic rubber, or a thermoplastic resin;
adding to the base polymer at least one antifouling component selected from capsaicin, medetomidine, tralopyril, zinc pyrithione, or combinations thereof;
adding to the base polymer at least one hydrophobic additive selected from polydimethylsiloxane, polytetrafluoroethylene, a fluoropolymer, or a surface-modified nanoparticle; and
compounding the base polymer, antifouling component, and hydrophobic additive under conditions that maintain dispersion of the additives without degradation of the active ingredients,
wherein the resulting polymer composition exhibits resistance to macrofouling and superhydrophobic surface behavior.

16. The method of claim 15, wherein the antifouling component comprises a pre-formulated antifouling composition blended into the polymer during compounding.

17. The method of claim 15, wherein the antifouling component comprises a pure or encapsulated active ingredient added directly to the molten polymer.

18. The method of claim 15, wherein both a pre-formulated antifouling composition and a directly added antifouling active ingredient are incorporated into the polymer to provide staged antifouling activity.

19. The method of claim 15, further comprising forming the compounded polymer into an article by extrusion, injection molding, or compression molding.

20. The method of claim 15, further comprising applying plasma treatment or laser texturing to the surface of the article to increase nanoscale roughness and enhance hydrophobicity.
